(19) United States
(12) Patent Application Publication
(10) Pub. No.: US 2012/0127497 A1
(43) Pub. Date: May 24, 2012

(54) METHOD AND SYSTEM OF DISPLAYING PRINTS OF RECONSTRUCTED 3D IMAGES

(75) Inventors: Assaf Zomet, Jerusalem (IL); Duby Hodd, Tel-Aviv (IL)

(73) Assignee: HumanEyes Technologies Ltd., Jerusalem (IL)

(21) Appl. No.: 13/388,069

(22) PCT Filed: Aug. 3, 2010
(86) PCT No.: PCT/IL10/00632

§ 371 Date: Jan. 31, 2012

Related U.S. Application Data
(60) Provisional application No. 61/230,781, filed on Aug. 3, 2009.

(51) Int. Cl. G06K 15/02

(52) U.S. Cl. 358/1.9

(57) ABSTRACT

A method of providing a composite image for lenticular printing. The method comprises providing a plurality of reconstructed volume images, providing an indication of a reference zone in at least one of the plurality of reconstructed volume images, forming a composite image by interlacing at least two of the plurality of reconstructed volume images, the composite image forms stereoscopic effect depicting the reference zone at a selected distance from the composite image when attached to an image separating mask, and outputting the composite image.

### RELATED APPLICATION

This application claims priority from U.S. Patent Application No. 61/230,781, filed on Aug. 3, 2009. The content of the above document is incorporated by reference as if fully set forth herein.

### FIELD AND BACKGROUND OF THE INVENTION

The present invention, in some embodiments thereof, relates to methods and systems of imaging and, more particularly, but not exclusively, to methods and systems of creating prints of reconstructed 3D images.

Lenticular printing is a process consisting of creating a lenticular image from at least two existing images, and combining it with a lenticular lens. This process can be used to create a dynamic image, for example by interlacing frames of animation that gives a motion effect to the observer or a set of alternate images that each appears to the observer as transforming into another. Once the various images are collected, they are flattened into individual, different frame files, and then digitally combined into a single final file in a process called interlacing. Alternatively and additionally, this process can be used to create stereoscopic three dimensional images by interlacing images of different perspectives of a 3D scene. When looking on the lenticular image via the lenticular lens, each eye of the viewer sees a different perspective, and the stereoscopic effect creates a three dimensional perception in the viewer's brain.

Lenticular printing to produce animated or three dimensional effects as a mass reproduction technique started as long ago as the 1940s. The most common method of lenticular printing, which accounts for the vast majority of lenticular images in the world today, is lithographic printing of the composite image directly onto the flat surface of the lenticular lens sheet.

Various lenticular printing products have been developed during the years. For example, U.S. Pat. No. 6,406,428, filed on Dec. 15, 1999 describes an ultrasound lenticular image product comprising: a lenticular lens element; and a composite image associated with the lenticular lens element. The composite image presents a sequence of ultrasound images of a subject of interest internal to a living being, such as the motion of a fetus carried in the womb of a pregnant woman.

### SUMMARY OF THE INVENTION

According to some embodiments of the present invention there is provided a method of providing a composite image for lenticular printing. The method comprises receiving a plurality of reconstructed volume images set according to an indication of a reference zone depicted in at least one of them, forming a composite image by interlacing at least two of the plurality of reconstructed volume images, the composite image forming a stereoscopic effect depicting the reference zone at a selected distance from the composite image when attached to an image separating mask, and

outputting the composite image.

Optionally, the at least two interlaced reconstructed volume images depict the reference zone in a common location.

Optionally, the method further comprises selecting the selected distance from a predefined range.

Optionally, the reference zone is selected from a group consisting of an area a line, a point, a surface, a curve, and a volumetric area.

Optionally, the method further comprises marking the indication on a presentation of a volume depicted in the plurality of reconstructed volume images.

More optionally, the marking comprises rendering the plurality of reconstructed volume images while maintaining the reference zone in a common display location.

Optionally, the plurality of reconstructed volume images are of a fetus captured during a sonography procedure on a pregnant woman.

Optionally, the outputting comprises printing the composite image on a surface of the image separating mask to create the lenticular printing product.

Optionally, the outputting comprises printing the composite image and laminating the printed composite image on a surface of the image separating mask to create the lenticular printing product.

Optionally, the forming being performed according to a viewing angle of the image separating mask.

Optionally, the receiving comprising allowing an operator to manually mark the reference zone.

Optionally, the reference zone confine an area depicting at least one anatomic feature.

Optionally, the method further comprises automatically selecting the reference zone.

Optionally, the method further comprises shifting at least one of the at least two reconstructed volume images according to its location.

According to some embodiments of the present invention there is provided a method of a system of providing images for lenticular printing. The system comprises a display which presents at least one of a plurality of reconstructed volume image, a marking module for marking a reference zone depicted in at least one of the reconstructed volume images, a computing unit which interlaces at least two of the plurality of reconstructed volume images to form a composite image, the composite image shaping a stereoscopic effect depicting the reference zone at a selected distance therefrom when being attached to an image separating mask, and an output unit which outputs the composite image for generating a lenticular printing product.

Optionally, the display and the marking module are installed in a client terminal, the computing unit receiving the at least two of the plurality of reconstructed volume images via a communication network.

Optionally, the plurality of reconstructed volume images are a plurality of reconstructed volume images of a fetus generated during a sonography procedure on a pregnant woman.

Optionally, the marking module comprises a user interface for allowing a user to mark manually the reference zone.

Optionally, the marking module automatically marks the reference zone.

According to some embodiments of the present invention there is provided an article of a three dimensional (3D) lenticular imaging. The article comprises an image separating mask of lenticular imaging and a composite image which interlaces a plurality of ultrasonic images depicting a common reference zone and attached to the image separating mask. The composite image is an outcome of interlacing a plurality of reconstructed three dimensional (3D) images captured during a common sonography procedure of a pregnant woman, the plurality of ultrasonic images being interlaced so as to form a stereoscopic effect depicting the common reference zone at a selected distance from the composite image when being attached to the image separating mask.

Optionally, the reference zone is selected from a group consisting of: an area a line, a point, a surface, a curve, a volumetric area, and an anatomic feature.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volitile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary lenticular imaging system for creating a composite image for lenticular printing, according to some embodiment of the present invention;

FIG. 2 is another schematic illustration of another exemplary lenticular imaging system for creating a composite image for lenticular printing, according to some embodiment of the present invention;

FIG. 3 is a flowchart of a method for creating a composite image for lenticular printing, based on reconstructed 3D images, according to some embodiment of the present invention;

FIGS. 4A-4C are images of a window of a graphical user interface which presents slice images of a 3D volume reconstructed according to ultrasonic images and marking of a reference zone thereon, according to some embodiment of the present invention;

FIG. 4D is a window of a graphical user interface which presents an image of a 3D volume reconstructed according to ultrasonic images, according to some embodiment of the present invention;

FIG. 5A is an exemplary reconstructed 3D image, where a reference zone is marked, according to some embodiment of the present invention;

FIG. 5B depicts a schematic lateral illustration of a lenticular printing product and a viewer;

FIGS. 5C and 5D are reconstructed 3D images depicting a fetus finger tip whose perceived lenticular depth is illustrated in FIG. 5B;

FIGS. 6A and 6B are reconstructed 3D images depicting a fetus eye;

FIG. 6C is a lenticular printing product depicting a reference zone to be perceived by the viewer in a stereoscopic effect which coincides with a predefined or a selected lenticular depth, according to some embodiment of the present invention; and

FIG. 7 is a flowchart of a method of automatically creating a composite image for lenticular printing from a sequence of rendered reconstructed 3D images, according to some embodiments of the present invention.

### DESCRIPTION OF EMBODIMENTS OF THE INVENTION

The present invention, in some embodiments thereof, relates to methods and systems of imaging and, more particularly, but not exclusively, to methods and systems of displaying prints of reconstructed volume images.

According to some embodiments of the present invention there are provided systems and methods of providing a composite image interlacing a plurality of reconstructed volume images for lenticular printing products. The composite image is interlaced so as to form a stereoscopic effect depicting a reference zone, which is depicted in the reconstructed volume images, at a selected distance therefrom, when being attached to an image separating mask. In such embodiments, outputs of medical imaging modalities, which are set to image volumetric elements such as internal organs and/or a fetus, may be interlaced with a selected or predefined lenticular depth. Optionally, the reconstructed volume images are based on data acquired using an ultrasonic probe, for example during a fetal anatomy survey of a fetus. Optionally, the system is at least partly installed in a 3D imaging terminal. In such an embodiment, reconstructed volume images for interlacing may be selected and forwarded to a computing unit which computes a composite image and forwards it for printing.

Optionally, the reference zone is manually selected by an operator, for example by marking one or more anatomic features in one or more reconstructed volume images. This marking may be referred to herein as a reference zone indication. The reference zone may be manually marked in a number of reconstructed volume images. Additionally or alternatively, a reference zone may be optionally predefined, or may be automatically identified. Such identification may be used for automatically generating composite images without the need to involve an operator in the process.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

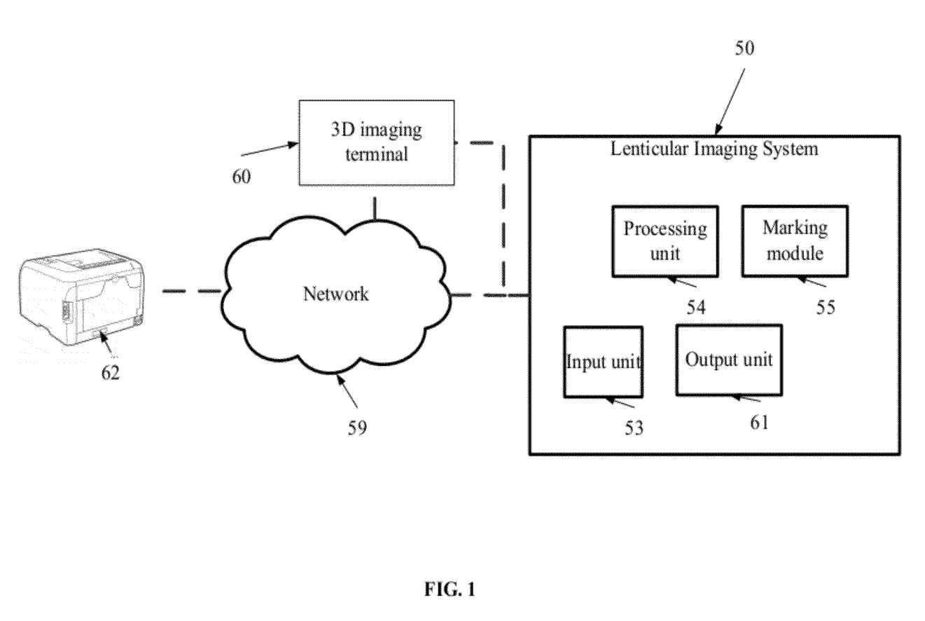

Reference is now made to FIG. 1, which is a schematic illustration of a lenticular imaging system 50 for creating a composite image 51 for lenticular printing, based on reconstructed three dimensional (3D) volume images, according to some embodiment of the present invention. As used herein, a reconstructed volume image means a 2D image which depicts a reconstructed volume, a slice image of volumetric data, a rendered image of volumetric data acquired by 3D ultrasound (including 4D ultrasound) modality, see Benacerraf et al.; Benson, C B; Abuhamad, A Z; Copel, J A; Abramowicz, J S; Devore, G R; Doubilet, P M; Lee, W et al. (2005), “Three- and 4-dimensional ultrasound in obstetrics and gynecology: proceedings of the american institute of ultrasound in medicine consensus conference”. Journal of ultrasound in medicine: official journal of the American Institute of Ultrasound in Medicine (J Ultrasound Med.) 24 (12): 1587-1597 and Benoit B, Chaoui R (2004), “Three-dimensional ultrasound with maximal mode rendering: a novel technique for the diagnosis of bilateral or unilateral absence or hypoplasia of nasal bones in second-trimester screening for Down syndrome”. Ultrasound in Obstetrics and Gynecology (Ultrasound in Obstetrics and Gynecology) 25 (1): 19-24, which are incorporated herein by reference. The reconstructed volume image may also mean a 2D image which depicts a 3D volume reconstructed based on any medical imaging modality, for example magnetic resonance imaging (MRI) acquiring device, computerized tomography (CT) acquiring device, X-ray acquiring device, and/or positron emission tomography (PET) acquiring device. An image from which a volume was reconstructed also depicts the volume and hence is also included under the definition of reconstructed volume images.

It should be noted that though the description herein focuses on a sonography procedure based on 3D ultrasound images, the lenticular imaging system 50 may be used for interlacing images captured using any of the aforementioned imaging modalities. The lenticular imaging system 50 may be implemented as an independent device set to connect to an existing 3D imaging terminal 60, such as a 3D ultrasound imaging stand, which capture ultrasound volumes and optionally present reconstructed volume images. For example, the lenticular imaging system 50 may interface, using an input interface 53, with an ultrasound imaging terminal 60, such as GE Logiq P50F General Electric™. The input interface 53 may be directly connected to the 3D imaging terminal 60 and/or via a network 59. In such an embodiment, 3D ultrasound images are presented on the display of the ultrasound system and reconstructed volume images are forwarded as input images to the system 50. Alternatively, the lenticular imaging system 50 may be an imaging system having an imaging unit that operates as a common ultrasound system for performing sonography procedure procedures, such as fetal anatomy survey, nuchal transparency, and the like. In such an embodiment, the input interface is an integration module that is set to receive reconstructed volume images that are generated by a reconstruction module of the imaging unit.

The lenticular imaging system 50 optionally comprises a display (not shown) which presents a plurality of reconstructed volume images of a fetus, for example during and/or after a sonography procedure of a pregnant woman.

The lenticular imaging system 50 further comprises a marking module 55 for assisting in the process of creating a composite image. The marking module 55 optionally a user interface, namely a man machine interfaces, such as a keyboard, a keypad, a touch screen, a mouse, and the like. The user interface 55 allows the user to mark, in one or more reconstructed volume images, a reference zone and optionally also to select reconstructed volume images for interlacing, for example as further described below. Optionally, the user interface 55 includes a graphical user interface (GUI) that is presented on the display (not shown), during and/or after the capturing of the reconstructed volume images and allows marking the reference zone in one or more reconstructed volume images, for example by placing a reference zone indication. The reference zone is optionally an area, a line, a curve, a surface, a volumetric area and/or a point selected by one or more pointers indicative of one or more locations in the displayed image. Optionally, the reference zone depicts one or more anatomic organs, or a portion of an anatomic organ, for example as described below.

Additionally or alternatively, the marking module 55 automatically selects the reconstructed volume images for interlacing and/or automatically marks a reference zone in one or more reconstructed volume images. The marking may be made by processing the reconstructed volume images to identify one or more anatomic organs, or a certain portion of an anatomic organ, for example based on known image processing algorithms. The identification of the one or more pointers may be performed by matching between the reconstructed volume images and a reference model and/or pattern. In another embodiment, features located in a certain area in a certain reconstructed volume image, for example an area set by a set of fixed coordinates are identified such that their location in the reconstructed volume can be determined by matching areas, which depict the same scene, in at least one other reconstructed volume image.

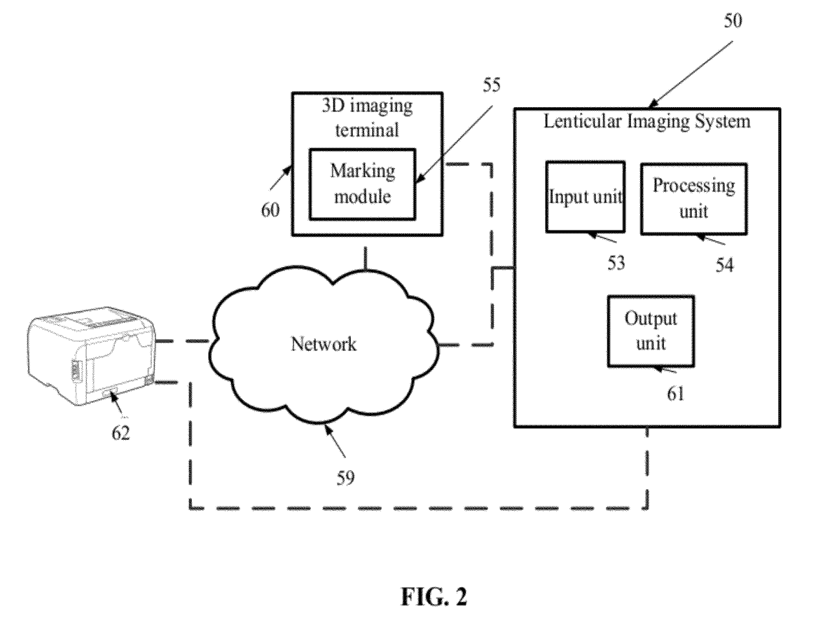

According to some embodiments of the present invention, for example as depicted in FIG. 2, the marking module 55 is installed in the 3D imaging terminal, for example as an add-on or an integrated tool of a module for presenting 3D reconstructed volume images. In such an embodiment, the marking of the reference zones, for example as outlined above and described below, is made by the operator of the 3D imaging terminal 60. In addition, the reconstructed volume images for interlacing, are optionally also locally stored at the 3D imaging terminal 60. These images are then sent to the lenticular imaging system 50 which creates the composite image accordingly, for example as described below.

The lenticular imaging system 50 further comprises a processing unit 56 which computes a composite image by interlacing the reconstructed volume images, for example as described below. The composite image is created for a lenticular printing product so as to form a stereoscopic effect depicting the marked reference zone at a selected distance from its surface.

The lenticular imaging system 50 further comprises an output unit 61, such as a controller or a printing interface, which instructs the printing of the composite image, or such as a module for outputting the composite image to a digital file that is to be printed. As used herein, printing means any type of realizing the composite image, for example printing using an inkjet printer, an offset printer, a dye sublimation printer, a silver halide image formation system and the like.

The instructions may be sent to an integrated printer and/or to an external printer, optionally designated for lenticular printing products, as known in the art. The printer may be local or remote, for example as shown at 62. The lenticular printing product may be formed by attaching the composite image to an image separating mask. As used herein, an image separating mask means a parallax barrier, a grating, a lenticular lenses array, a diffractive element, a multi image display screen, an array of lenses for integral photography (IP), for example as described in U.S. Pat. No. 5,800,907, filed on May 23, 1996 that is incorporated herein by reference and any optical element that is designed for directing light from image regions, such as strips, of image A of the composite image differently from light from image regions of image B of the composite image so as to create different viewing windows at different viewing distances. As used herein, precision slits means slits or any other optical sub elements, which are designed for directing light from regions of different images of the composite image in a different manner.

The lenticular image product demonstrates a presentation with a stereoscopic effect, for example of fetus imaged in the reconstructed volume images or any part thereof. The stereoscopic effect of the created lenticular printing product depicts the marked reference zone at a selected distance from its surface. For example, the stereoscopic effect provides a visualization of a 3D image representation of a fetus, based on image acquired by the ultrasound system, where the reference zone is placed in a selected distance, for example on the surface of the lenticular image product, 0.5 centimeters from the lenticular image product, 10 centimeters from the lenticular image product or any intermediate or longer distance.

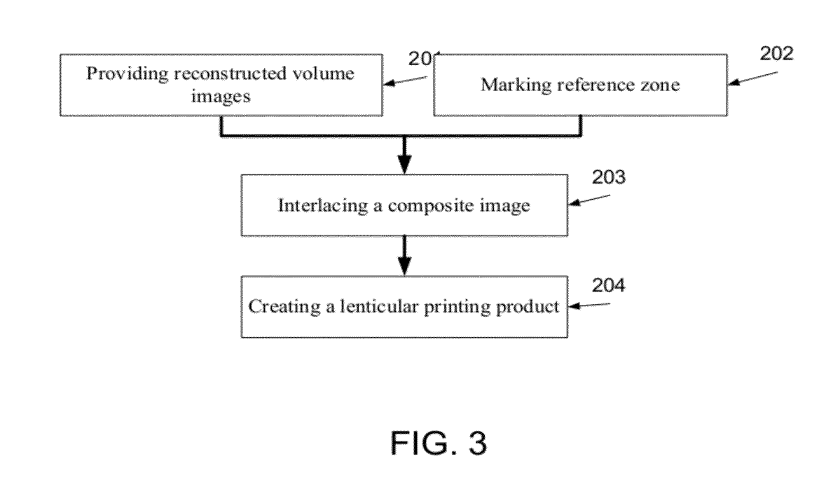

Reference is now also made to FIG. 3, which is a flowchart of a method for creating a composite image 51 for lenticular printing, based on reconstructed volume images, according to some embodiment of the present invention.

As shown at 201, an image creation procedure is performed where a sequence of 3D images are reconstructed based on volumetric data, for example a sonography procedure on a pregnant woman. The sonography procedure may be performed in advance or while facilitating the performance of the method for creating a composite image 200. During the procedure at least one volume is acquired.

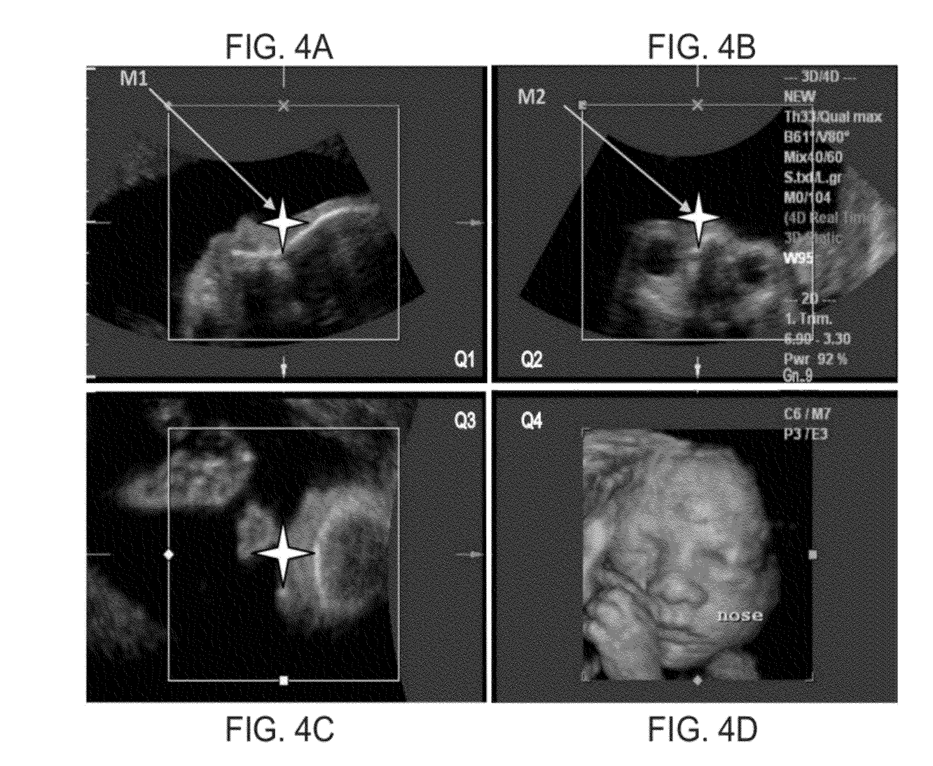

As described above, the lenticular imaging system 50 includes the input interface 53 for receiving reconstructed volume images. These images are optionally two dimensional (2D) images rendered from the volumetric data. During the sonography procedure, reconstructed volume images of the fetus are presented on a screen or printed as a set of hard copy images. Exemplary reconstructed volume images are depicted in FIG. 4A, and 4D.

As shown at 202, a reference zone is marked in one or more of the reconstructed volume images. As described above, a user interface such as a GUI 55 allows the user to manually mark the reference zone. For example, FIGS. 4A-4C depict a window of a GUI which presents slice images of a reconstructed 3D volume and FIG. 4D which depicts a rendered reconstructed 3D image. The GUI shows slices of a volumetric three dimensional image representation of a fetus (Q1, Q2, Q3). According to some embodiments of this invention, the operator uses such a GUI to match a reference zone, denoted herein by M1 and M2, to an anatomic feature which appears in ultrasound images (Q1, Q2). Optionally, the marking is performed by moving the ultrasound images, for example by dragging, until an anatomic feature depicted therein coincides with the one or more reference zone marks. Additionally or alternatively, the marking is performed by moving one or more markers until they coincide with the anatomic feature in one or more ultrasound images, optionally sequentially. By the marking, the anatomic feature may be designated to have a predefined or selected lenticular depth. Alternatively, the reference zone is identified automatically, for example an eye, a face center, a tummy center and the like. Such automatic identification can be done, for example, using methods known in the art, for example as described in U.S. Pat. No. 5642431, which is incorporated herein by reference reference. Now, at least two reconstructed volume images which depict the reference zone are generated.

As shown at 203, a composite image is formed by interlacing the at least two of plurality of reconstructed volume images. The composite image is formed so as to allow the creation of a lenticular printing product which depicts the reference zone with a selected lenticular depth. Optionally, as described above, the lenticular imaging system 50 interlaces a plurality of reconstructed volume images which are received from a 3D imaging terminal 60, for example via the network 59. Alternatively, the lenticular imaging system 50 interlaces a plurality of reconstructed volume images which are captured by a 3D imaging terminal which is directly and locally connected thereto.

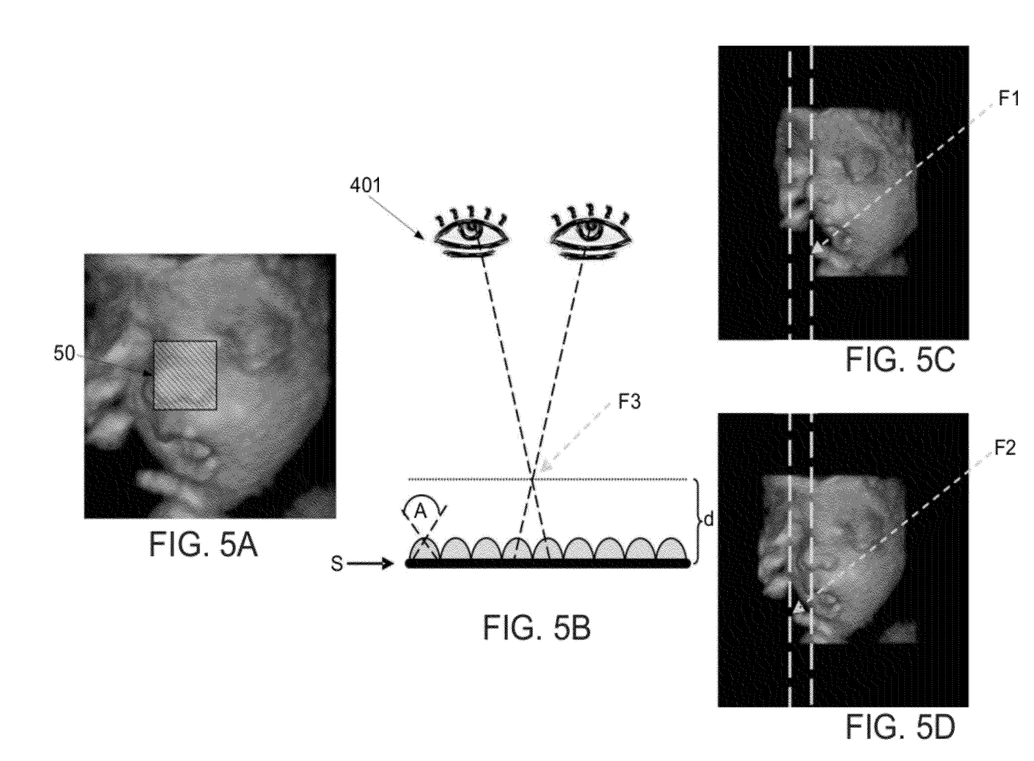

For example, a reference is also made to FIG. 5A which is an exemplary reconstructed volume image, where the marked reference zone, denoted herein as 450, is a square area that confines a fetus nose. It should be noted that the reference zone may by in any shape or size, for example a point, an area, a surface or a volume. The reference zone 450 is set to allow the user to select an anatomic feature which is depicted in the reconstructed volume images. Images depicting this anatomic feature are later interlaced to allow the generation of a lenticular image product that presents the reference zone at a predefined or selected lenticular depth. As used herein, a lenticular depth means a distance between a perceived location of a stereoscopic effect formed by the lenticular image and the composite image thereof. For example, FIG. 5B depicts a schematic lateral illustration of a lenticular printing product, which interlaces the images depicted in FIGS. 5C and 5D, according to some embodiments of the present invention. The lenticular printing product presents a stereoscopic effect formed by the composite image of the physical lenticular image product (S) to a viewer 401 where d denotes a lenticular depth as a distance between it's a perceived location (F3). It should be noted that the reference zone may be defined to include any anatomic feature and/or a point, a line, a curve, and/or an area and/or a surface and/or a volumetric shape in a distance within a given range from an anatomic feature.

The reference zone is optionally set by a pointer indicative of a location of a common anatomic organ. Optionally, the pointer is designated by identifying an anatomic feature in the three dimensional image representations, such as the eye of the fetus. The composite image is interlaced so as to create a composite image in a manner that the lenticular depth of the selected anatomic feature in the reference zone conforms to the predefined or selected depth range. Optionally, this identification is done manually, for example by the person who operates the scanning device. In such an embodiment, a user may manually choose which anatomic feature to designate, based on her/his artistic preferences or based on general guidelines.

According to some embodiments of the present invention, the images which are selected for interlacing are formed by rendering the reconstructed volume images and then transforming the rendered images so as to create predefined shifts of the rendered reference zone across the rendered reconstructed volume images.

According to some embodiments of the present invention, the images which are selected for interlacing are formed by rendering the reconstructed volume images while maintaining the reference zone in a fixed display location and selecting said one or more of the rendered reconstructed volume images.

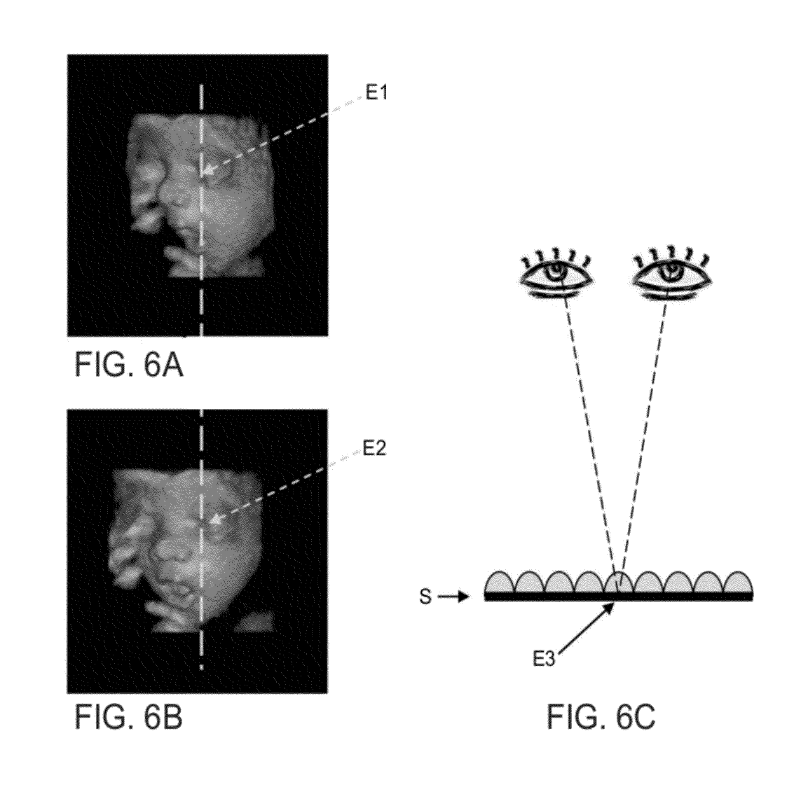

Optionally, the reference zone is located in a common location in relation to the coordinates of different interlaced images optionally by rendering images as a rotation of a 3D volume around the reference zone which remains stationary. For example, the views depicted in FIGS. 6A and 6B in which the fetus eye respectively marked as E1 and E2 is stationary. Optionally, these images are interlaced so as to form a composite image in which the reference zone, for example the fetus's eye (E3) in FIG. 6C, is perceived by the viewer in a stereoscopic effect which coincides with a predefined or a selected lenticular depth, for example the surface of the composite image (S), 0.5 cm above the surface of composite image, 1.5 cm above the surface of composite image or any intermediate or smaller distance. When the feature is stationary, as described here, the depth is zero. Other depths can be achieved by shifting the rendered images laterally so as to get constant shifts between the images.

Optionally, the marking of one or more reference zones, performed at 202, is also indicative of one or more reconstructed volume images which are selected for interlacing. In one example, the interlaced images are the images in which the reference zone is selected. In another example, the image composition is formed by interlacing the reconstructed volume image on which the reference zone is marked and one or more additional reconstructed volume images which are manually or automatically selected so as to form a stereoscopic effect in which the reference zone is depicted with a predefined or a selected lenticular depth. Alternatively, the interlaced images are not the images in which the reference zone is marked and selected so as to form a stereoscopic effect in which the reference zone is depicted with a predefined or a selected lenticular depth. The selected reconstructed volume images are optionally part of a sequence of reconstructed volume images that depicts a fetus from a plurality of point of views. The reconstructed volume images share a common size and therefore a common coordinate system. Optionally, the reconstructed volume images, which are selected for interlacing, depict the reference zone substantially in a common location. In such an embodiment, the lenticular depth is substantially zero.

This allows, as shown at 204, creating a lenticular printing product based on the composite image. When the composite image is attached to an image separating mask, it forms a lenticular image product in which the reference zone may be perceived in a common lenticular depth from different points of view in relation to the surface of the composite image.

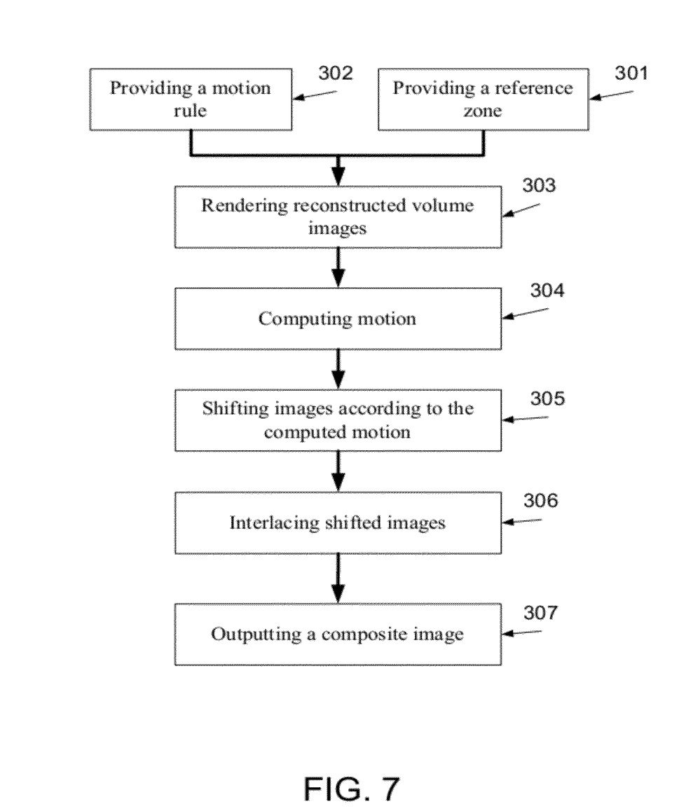

Reference is now made to FIG. 7, which is a flowchart of a method of automatically creating a composite image for lenticular printing from a sequence of rendered reconstructed volume images, optionally a sequence of reconstructed volume images rendered during a fetal anatomy survey, according to some embodiments of the present invention. As shown at 301, a reference zone is defined, for example an area around the center of an reconstructed volume image, for example, as shown at FIG. 5A, a quadratic area denoted as R, of 1/9 of the total area of the reconstructed volume image. As shown at 302, a motion rule that defines a motion of the reference zone between reconstructed volume images is provided. Alternatively, R is identified automatically around a feature of interest, for example an eye, a face center, a tummy center and the like. Such automatic identification can be done, for example, using methods known in the art such as described in U.S. Pat. No. 5,642,431, which is incorporated herein by reference.

As shown at 303, a set of views U₍ₗ₎, . . . , U₍ₖ₎ that are rendered from the three dimensional image representation is given.

Now, as shown at 304, the motion between at least two views, in the region R, is calculated, for example the motion between U_{(k/2)} and U_{(k/2+1)}. As shown at 305, these views are shifted, optionally laterally, according to the computed motion, so as to create shifted views that comply with the provided motion rule. As shown at 306, the shifted views are now interlaced to create a composite image for lenticular printing. Optionally, the views are selected so that a reference zone is depicted with a predefined or a selected lenticular depth. The reference zone, in the three dimensional representation, is defined to be whatever depicted in a certain area R of the image and the designation to a lenticular depth is done by constraining the locations of the feature depicted in R in the different views. In general, the designation of a zone to a selected and/or a predefined lenticular depth may be rephrased to a designation of a zone constrained to predefined rules such that it appears in different locations in different views (U₍ₗ₎, . . , U₍ₖ₎). By controlling the locations it is possible to control the lenticular depths and vice versa. For example, as shown in FIG. 5B, the lenticular depth is determined by taking into account angle A of the lenticular lenses of the image separating mask. In other words, an alternative definition of the interlaced composite image is an image in which a reference zone appears via the image separating mask at locations according to a predefined rule when viewed from different angles, namely different perspective views.

Optionally, the relation between disparities and lenticular depth may be computed mathematically, given the printing parameters and lens angular range. In such embodiments, the angular domain of a lenticular lens, for example as published by lenticular lens manufacturers, is a range of degrees between the most extreme views. A disparity between consecutive views (measured in inch units of the final product) is computed by

DP=tan(A/2)*DD*PP/RR Equation 1:

where DP denotes the calculated disparity, RR denotes print resolution and PP denotes lenticular lens pitch, and DD denotes a point's depth (inches).

An exemplary automatic method of automatically creating a composite image takes the set of views U₍ₗ₎, . . . , U₍ₖ₎ as input, computes a shift (Ax, Ay) between at least two views U_{(k/2)}, U_{(k/2+1)} in the region R, for example using global motion algorithm, and shifts the images U₍ₗ₎, . . . , U₍ₖ₎ according to the given motion rule. For example, if the rule is to have a certain DP between each pair of consecutive views, then the views U₍ⱼ₎ are shifted by (DP-Ax)*(j-k/2).

Optionally one or more data layers are printed on or otherwise added to the composite image. The data layer may include graphic elements, such as texts, image data depicting the fetus or his mother, a logo and the like. For example, dimensions of the fetus, an overlay of a picture or a drawing of a mother, for example the mother of the fetus, the name and/or logo of a physician and/or a brand name, such as a clinic where the image was acquired etc.

This process allows creating a lenticular article which images a good distribution of depth within the possible depth range of a lenticular print product. For example, optionally, the views in the composite image are selected so that the stereoscopic effect of the physical product divides the anatomic features between negative and positive depths in a manner that some anatomic features may have popping out parts and some “behind the print” parts. For example, if the image in FIG. 6A is a view presented from a first point of view, for example straight ahead, the cheek pop outs whereas the right eye of the fetus (not E1) appears behind. Such an oblique view of the face, together with the designation of the eye E1 to a given depth, provides a compelling depth perception.

Another benefit of this invention is the ability to produce sharp images. By designating features to appear to be close to the surface S of the printed surface, we produce sharper image of these features in the physical product. The exact depth to designate depends on the type of lenticular lens and in the algorithms for creating the composite image, but as a rule of thumb it is preferred to designate more interesting features to small depths such that the features will be perceived to be close to S, the surface of the physical product. As shown at 307, the composite image is outputted, optionally forwarded, to a printing unit, for example as described above.

It is expected that during the life of a patent maturing from this application many relevant systems and methods will be developed and the scope of the term a reconstructed volume image, an imaging modality, a 3D ultrasound image, and an image separating mask is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of providing a composite image for lenticular printing, comprising:
receiving a plurality of reconstructed volume images set according to an indication of a reference zone depicted in at least one of them;
forming a composite image by interlacing at least two of said plurality of reconstructed volume images, said composite image forming a stereoscopic effect depicting said reference zone at a selected distance from said composite image when attached to an image separating mask; and
outputting said composite image.

2. The method of claim 1, wherein said at least two interlaced reconstructed volume images depict said reference zone in a common location.

3. The method of claim 1, further comprising selecting said selected distance from a predefined range.

4. The method of claim 1, wherein said reference zone is selected from a group consisting of an area a line, a point, a surface, a curve, and a volumetric area.

5. The method of claim 1, further comprising marking said indication on a presentation of a volume depicted in said plurality of reconstructed volume images.

6. The method of claim 5, wherein said marking comprises rendering said plurality of reconstructed volume images while maintaining said reference zone in a common display location.

7. The method of claim 1, wherein said plurality of reconstructed volume images are of a fetus captured during a sonography procedure on a pregnant woman.

8. The method of claim 1, wherein said outputting comprises printing said composite image on a surface of said image separating mask to create said lenticular printing product.

9. The method of claim 1, wherein said outputting comprises printing said composite image and laminating said printed composite image on a surface of said image separating mask to create said lenticular printing product.

10. The method of claim 1, wherein said forming being performed according to a viewing angle of said image separating mask.

11. The method of claim 1, wherein said receiving comprising allowing an operator to manually mark said reference zone.

12. The method of claim 1, wherein said reference zone confine an area depicting at least one anatomic feature.

13. The method of claim 1, further comprising automatically selecting said reference zone.

14. The method of claim 1, further comprising shifting at least one of said at least two reconstructed volume images according to its location.

15. A system of providing images for lenticular printing, comprising:
a display which presents at least one of a plurality of reconstructed volume image;
a marking module for marking a reference zone depicted in at least one of said reconstructed volume images;
a computing unit which interlaces at least two of said plurality of reconstructed volume images to form a composite image, said composite image shaping a stereoscopic effect depicting said reference zone at a selected distance therefrom when being attached to an image separating mask; and
an output unit which outputs said composite image for generating a lenticular printing product.

16. The system of claim 15, wherein said display and said marking module are installed in a client terminal, said computing unit receiving said at least two of said plurality of reconstructed volume images via a communication network.

17. The system of claim 15, wherein said plurality of reconstructed volume images are a plurality of reconstructed volume images of a fetus generated during a sonography procedure on a pregnant woman.

18. The system of claim 15, wherein said marking module comprises a user interface for allowing a user to mark manually said reference zone.

19. The system of claim 15, wherein said marking module automatically marks said reference zone.

20. An article of a three dimensional (3D) lenticular imaging, comprising:
an image separating mask of lenticular imaging; and
a composite image which interlaces a plurality of ultrasonic images depicting a common reference zone and attached to said image separating mask;
wherein said composite image is an outcome of interlacing a plurality of reconstructed three dimensional (3D) images captured during a common sonography procedure of a pregnant woman, said plurality of ultrasonic images being interlaced so as to form a stereoscopic effect depicting said common reference zone at a selected distance from said composite image when being attached to said image separating mask.

21. The article of claim 20, wherein said reference zone is selected from a group consisting of: an area a line, a point, a surface, a curve, a volumetric area, and an anatomic feature.
